(19) United States
(12) Patent Application Publication
(10) Pub. No.: US 2026/0249829 A1
(43) Pub. Date: Aug. 27, 2026

(54) BRAKING DEVICE

(71) Applicant: ADVICS CO., LTD., Kariya-shi, Aichi-ken (JP)

(72) Inventor: Yuto SAINO, Kariya-shi, Aichi-ken (JP)

(73) Assignee: ADVICS CO., LTD., Kariya-shi, Aichi-ken (JP)

(21) Appl. No.: 18/995,430

(22) PCT Filed: Jul. 27, 2023
(86) PCT No.: PCT/JP2023/027652

§ 371 Date: Jan. 16, 2025

(30) Foreign Application Priority Data
Jul. 27, 2022 (JP) 2022-119982

(51) Int. Cl. B60T 13/74; B60T 13/58; F16D 65/18; F16D 121/04; F16D 121/24; F16D 123/00; F16D 125/06; F16D 125/40; F16D 127/02

(52) U.S. Cl. CPC B60T 13/746; F16D 65/18; B60T 13/588; F16D 2121/04; F16D 2121/24; F16D 2123/00; F16D 2125/06; F16D 2125/40; F16D 2127/02

(57) ABSTRACT

A braking device includes: a rotation member, a linear motion member movable in first and second directions when the rotation member is rotated in first and second rotational directions respectively, a piston capable of pressing a brake pad in the first direction by being pressed in the first direction by the linear motion member; and a protrusion protruding from the brake pad, accommodated in a recess in the piston, and having an inclined surface inclined obliquely with respect to a rotational axis. When the piston is rotated in the second rotational direction, the piston contacts the inclined surface of the brake pad at a recess first end surface, and presses the brake pad in the first direction, and when the protrusion is viewed in the first direction, a projected area of the inclined surface is greater than half of a projected area of the protrusion.

### TECHNICAL FIELD

The present disclosure relates to a braking device.

### BACKGROUND ART

Conventionally, a braking device is known that converts rotation of a rotation member driven by an electric motor into linear motion of a linear motion member, and presses a brake pad against a brake rotor by way of a piston by the linear motion member. The piston and the brake pad may be provided with a protrusion and a recess to be fitted to each other so as to restrict the rotation of the piston (Patent Literature 1).

### CITATIONS LIST

### Patent Literature

Patent Literature 1: JP 2017-155774 A

### SUMMARY

### Technical Problems

However, in the conventional configuration, when the rotation of the piston and the brake pad is restricted by the fitting of the protrusion and the recess, a large load may be applied to the electric motor or a mechanism that transmits the rotation between the electric motor and the rotation member. If the load is reduced, the durability of the braking device can be improved.

Therefore, the present disclosure has been made in view of the above, and provides a braking device capable of improving durability.

### Solutions to Problems

A braking device according to an embodiment of the present disclosure includes, as an example, a rotation member provided with one of a male screw and a female screw that meshes with the male screw, the rotation member being rotatable around a rotational axis; an electric motor that rotationally drives the rotation member, a linear motion member provided with the other of the male screw and the female screw, the linear motion member being movable in a first direction along the rotational axis when the rotation member is rotated in a first rotational direction around the rotational axis, and being movable in a second direction opposite to the first direction when the rotation member is rotated in a second rotational direction opposite to the first rotational direction; a brake pad spaced apart from the linear motion member in the first direction, a piston that is restricted from rotating around the rotational axis with respect to the linear motion member, is movable along the rotational axis with respect to the linear motion member, and is capable of pressing the brake pad in the first direction by being pressed in the first direction by the linear motion member, and a protrusion that protrudes from the brake pad, is accommodated in a recess provided in the piston, and has an inclined surface inclined with respect to the rotational axis, wherein the piston rotated in the second rotational direction comes into contact with the inclined surface of the brake pad at a recess first end surface, and presses the brake pad in the first direction, and when the protrusion is viewed in the first direction, a projected area of the inclined surface is greater than half of a projected area of the protrusion. Therefore, as an example, the inclination of the inclined surface with respect to a plane orthogonal to the rotational axis is small as compared with the case where the projected area of the inclined surface is smaller than half of the projected area of the protrusion. For this reason, when the piston is rotated in the second rotational direction, the reaction force in the first rotational direction received by the recess first end surface from the inclined surface becomes small. Therefore, for example, the load applied to the electric motor that drives the rotation member and the rotation transmission mechanism that transmits rotation between the electric motor and the rotation member is reduced, and the durability of the braking device can be improved.

### BRIEF DESCRIPTION OF DRAWINGS

FIG. 1 is a cross-sectional view schematically illustrating a braking device according to a first embodiment.

FIG. 2 is a cross-sectional view of a piston and a brake pad of the first embodiment taken along line F2-F2 of FIG. 1.

FIG. 3 is a plan view illustrating a protrusion of the first embodiment;

FIG. 4 is a cross-sectional view illustrating a part of the braking device of the first embodiment taken along line F4-F4 of FIG. 3.

FIG. 5 is a plan view illustrating a part of a piston and a brake pad according to a second embodiment.

### DESCRIPTION OF EMBODIMENTS

### First Embodiment

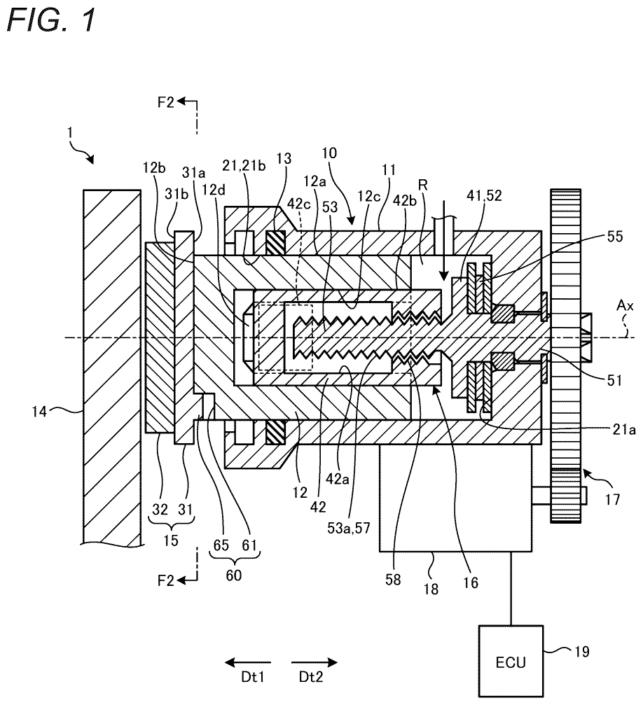

Hereinafter, a first embodiment will be described with reference to FIGS. 1 to 4. Note that, in the present specification, components according to embodiments and descriptions of the components may be described in a plurality of expressions. The components and the description thereof are examples, and are not limited by the expression of the present specification. Components may also be identified with names different from those in the present specification. In addition, the component may be described by an expression different from the expression in the present specification.

FIG. 1 is a cross-sectional view schematically illustrating a braking device 10 according to a first embodiment. The braking device 10 is mounted on a vehicle 1 such as an automobile. Note that the braking device 10 is not limited to this example. As illustrated in FIG. 1, the braking device 10 includes a caliper 11, a piston 12, a piston seal 13, a brake rotor 14, a brake pad 15, a rotation-linear motion conversion mechanism 16, a rotation transmission mechanism 17, an electric motor 18, and an ECU 19.

The braking device 10 can operate as a hydraulic brake and can also operate as an electric brake. For example, the caliper 11, the piston 12, the piston seal 13, the brake rotor 14, and the brake pad 15 constitute a hydraulic brake. In addition, the caliper 11, the piston 12, the piston seal 13, the brake rotor 14, the brake pad 15, the rotation-linear motion conversion mechanism 16, the rotation transmission mechanism 17, and the electric motor 18 constitute an electric brake. Note that the braking device 10 is not limited to this example.

The electric brake is a so-called electric parking brake (EPB). That is, the braking device 10 is configured such that the braking state by the electric brake function is maintained at the time of parking. Note that the electric brake may be operated at the time of traveling or at the time of temporary stop.

The caliper 11 is provided with a cylinder 21. The cylinder 21 is a substantially circular-column shaped hole opened to the outer surface of the caliper 11. In FIG. 1, the central axis Ax of the cylinder 21 is indicated by an alternate long and short dash line. That is, the cylinder 21 is extended along the central axis Ax. The central axis Ax is an example of a rotational axis. Note that the rotational axis may be different from the central axis of the cylinder 21.

In the present specification, an axial direction, a radial direction, and a circumferential direction are defined for the sake of convenience. The axial direction is a direction along the central axis Ax, and includes a first direction Dt1 and a second direction Dt2. The second direction Dt2 is a direction opposite to the first direction Dt1. The radial direction is a direction orthogonal to the central axis Ax. The circumferential direction is a direction around the central axis Ax.

The cylinder 21 is a bottomed hole opened in the first direction Dt1. The piston 12 is accommodated in the cylinder 21 so as to be movable in the axial direction. In the cylinder 21, a hydraulic chamber R is provided between the piston 12 and a bottom surface 21a of the cylinder 21 in the second direction Dt2.

The piston 12 has an outer peripheral surface 12a and an end surface 12b. The outer peripheral surface 12a is formed in a substantially cylindrical shape facing the outer side in the radial direction of the central axis Ax. The end surface 12b is provided at the end portion of the piston 12 in the first direction Dt1. The end surface 12b is formed to be substantially flat and faces the first direction Dt1.

The piston 12 is provided with a recess 12c. The recess 12c is a bottomed hole opened in the second direction Dt2. The piston 12 forms a part of the hydraulic chamber R. The recess 12c is formed in, for example, a substantially circular column shape. Note that the shape of the recess 12c is not limited to this example.

The outer peripheral surface 12a of the piston 12 and the inner peripheral surface 21b of the cylinder 21 face each other. The inner peripheral surface 21b is an inner surface of the caliper 11 formed in a substantially cylindrical shape facing the inner side in the radial direction of the central axis Ax.

A minute gap (clearance) is provided between the outer peripheral surface 12a of the piston 12 and the inner peripheral surface 21b of the cylinder 21. The piston 12 slides in the axial direction along the inner peripheral surface 21b in a state of being lubricated by the hydraulic oil existing in the gap.

The piston seal 13 is interposed between the outer peripheral surface 12a of the piston 12 and the inner peripheral surface 21b of the cylinder 21, and seals a gap between the outer peripheral surface 12a and the inner peripheral surface 21b. As a result, the piston seal 13 suppresses the hydraulic oil from leaking from the hydraulic chamber R through the gap.

The piston seal 13 is attached to the inner peripheral surface 21b of the cylinder 21 and is restricted from moving with respect to the caliper 11. Note that the piston seal 13 may be attached to the outer peripheral surface 12a of the piston 12.

The brake rotor 14 rotates integrally with the wheel of the vehicle 1. The brake rotor 14 is spaced apart from the cylinder 21 in the first direction Dt1. That is, the cylinder 21 is opened toward the brake rotor 14.

The brake pad 15 is located between the piston 12 and the brake rotor 14. The brake pad 15 is supported by, for example, the caliper 11 so as to be translatable in the axial direction. The brake pad 15 includes a back plate 31 and a friction material 32.

The back plate 31 has a receiving surface 31a and an attachment surface 31b. The receiving surface 31a is formed to be substantially flat and faces the second direction Dt2. The end surface 12b of the piston 12 and the receiving surface 31a of the back plate 31 face each other. The attachment surface 31b is located on the opposite side of the receiving surface 31a. The attachment surface 31b faces the brake rotor 14. The friction material 32 is attached to the attachment surface 31b and is located between the brake rotor 14 and the back plate 31.

When the fluid pressure in the hydraulic chamber R increases, the piston 12 is pressed in the first direction Dt1 by the fluid pressure and moved in the first direction Dt1. The piston 12 abuts on the receiving surface 31a of the back plate 31 and presses the back plate 31, thereby pressing the friction material 32 against the brake rotor 14. As a result, the wheel of the vehicle 1 is braked, and a braking state by the hydraulic brake is obtained.

The piston seal 13 has a retract function of pulling in the piston 12 in the second direction Dt2 by the elastic force and separating the end surface 12b of the piston 12 away from the back plate 31 as the fluid pressure in the hydraulic chamber R decreases. That is, when the pressing of the piston 12 against the back plate 31 is released with decrease in the fluid pressure of the hydraulic chamber R, the pressing of the friction material 32 against the brake rotor 14 by the piston 12 is released. As a result, the braking release state by the hydraulic brake is obtained.

The rotation-linear motion conversion mechanism 16 includes a rotation member 41 and a linear motion member 42. Each of the rotation member 41 and the linear motion member 42 is at least partially accommodated in the cylinder 21. The rotation member 41 is supported by the caliper 11 so as to be rotatable about the central axis Ax. The linear motion member 42 is attached to the rotation member 41 so as to be linearly movable in the axial direction according to the rotation of the rotation member 41.

The rotation transmission mechanism 17 is, for example, a speed reducer having a plurality of rotational elements such as gears. The rotation transmission mechanism 17 is located outside the cylinder 21 and is covered by, for example, a cover. The rotation transmission mechanism 17 transmits the rotation of the output shaft of the electric motor 18 to the rotation member 41. The rotation member 41 rotates about the central axis Ax by torque input from the rotation transmission mechanism 17.

The rotation member 41 includes a coupling portion 51, a flange 52, and a shaft 53. The coupling portion 51 is, for example, coupled to an output gear of the rotation transmission mechanism 17 through a hole opened in the bottom surface 21a of the cylinder 21, and rotates integrally with the output gear.

The flange 52 and the shaft 53 are located inside the cylinder 21. The flange 52 is located between the coupling portion 51 and the shaft 53, and is formed in a substantially disk shape bulging out in the radial direction from the coupling portion 51 and the shaft 53.

The shaft 53 protrudes from the flange 52 in the first direction Dt1. The shaft 53 is formed in a substantially cylindrical shape extending in the axial direction along the central axis Ax. In the present embodiment, the central axis Ax is also the central axis of the flange 52 and the shaft 53.

A thrust bearing 55 is provided between the flange 52 and the bottom surface 21a of the cylinder 21. The caliper 11 supports the rotation member 41 in the axial direction via the thrust bearing 55.

The shaft 53 has an outer peripheral surface 53a. The outer peripheral surface 53a is a substantially cylindrical curved surface extending in the axial direction and facing the outer side in the radial direction. A male screw 57 is provided on the outer peripheral surface 53a.

The linear motion member 42 is formed in a substantially cylindrical shape extending in the axial direction and surrounding the central axis Ax. The linear motion member 42 has an inner peripheral surface 42a and an outer peripheral surface 42b. The inner peripheral surface 42a is a substantially cylindrical curved surface extending in the axial direction and facing the inner side in the radial direction. The outer peripheral surface 42b is located on the opposite side of the inner peripheral surface 42a. The outer peripheral surface 42b is a substantially cylindrical curved surface extending in the axial direction and facing the outer side in the radial direction.

A female screw 58 is provided on the inner peripheral surface 42a. The female screw 58 meshes with the male screw 57 of the rotation member 41. Note that the rotation member 41 may be provided with a female screw, and the linear motion member 42 may be provided with a male screw.

A part of the rotation-linear motion conversion mechanism 16 is accommodated inside the recess 12c of the piston 12. A part of the shaft 53 of the rotation member 41 is located inside the recess 12c of the piston 12. Furthermore, the linear motion member 42 is provided to be movable in the axial direction inside the recess 12c.

The recess 12c of the piston 12 is provided with a guide groove 12d extending in the axial direction. For example, a projection 42c protruding from the outer peripheral surface 42b of the linear motion member 42 is fitted into the guide groove 12d. As a result, the piston 12 is restricted from rotating about the central axis Ax with respect to the linear motion member 42, and can move in the axial direction with respect to the linear motion member 42. Note that the piston 12 and the linear motion member 42 may be relatively slightly rotatable about the central axis Ax.

As described above, the male screw 57 of the rotation member 41 and the female screw 58 of the linear motion member 42 mesh with each other, and the relative rotation between the piston 12 and the linear motion member 42 is restricted. As a result, the linear motion member 42 can linearly move in the axial direction according to the rotation of the rotation member 41. In a different expression, the linear motion member 42 can substantially translate in the axial direction.

The electric motor 18 is driven by driving force based on the control signal. The electric motor 18 rotates the output shaft of the electric motor 18 to rotationally drive the rotation member 41 around the central axis Ax via the rotation transmission mechanism 17.

The brake pad 15 is spaced apart from the linear motion member 42 in the first direction Dt1, and the piston 12 is located between the brake pad 15 and the linear motion member 42. The linear motion member 42 can press the brake pad 15 by way of the piston 12 in accordance with the rotation of the rotation member 41.

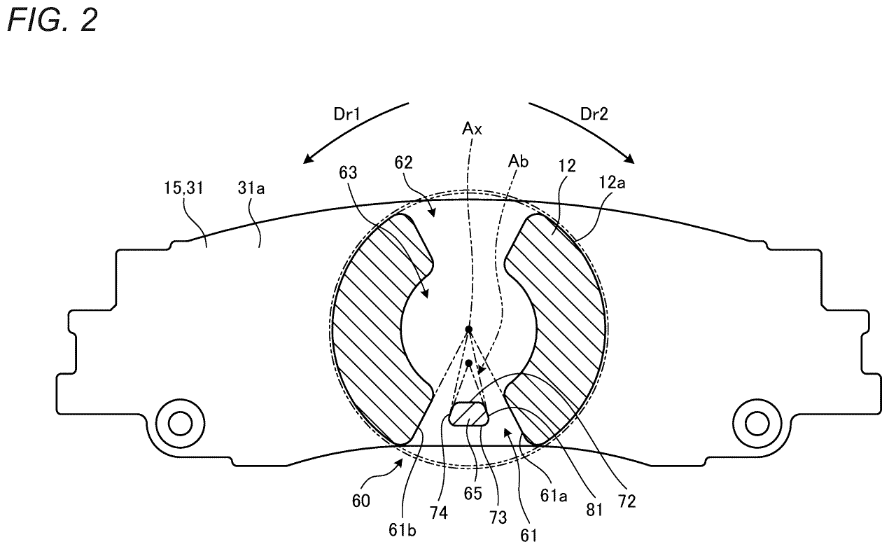

FIG. 2 is a cross-sectional view of the piston 12 and the brake pad 15 of the first embodiment taken along line F2-F2 of FIG. 1. The rotation member 41 illustrated in FIG. 1 is rotatable in a first rotational direction Dr1 and a second rotational direction Dr2 illustrated in FIG. 2. The first rotational direction Dr1 and the second rotational direction Dr2 are included in the circumferential direction. The second rotational direction Dr2 is a direction opposite to the first rotational direction Dr1.

When the output shaft of the electric motor 18 is rotates in one direction, the rotation member 41 is rotated in the first rotational direction Dr1. When the rotation member 41 is rotated in the first rotational direction Dr1, the linear motion member 42 moves straight (moves) in the first direction Dt1.

The linear motion member 42 moving in the first direction Dt1 presses the piston 12 in the first direction Dt1. The piston 12 pressed by the linear motion member 42 moves in the first direction Dt1 to abut on the receiving surface 31a of the back plate 31 of the brake pad 15.

The piston 12 presses the back plate 31 of the brake pad 15 in the first direction Dt1 by being pressed in the first direction Dt1 by the linear motion member 42. As a result, the piston 12 presses the friction material 32 against the brake rotor 14 via the back plate 31. As described above, the braking state by the electric brake function in which the wheel of the vehicle 1 rotating integrally with the brake rotor 14 is braked is obtained.

When the output shaft of the electric motor 18 is rotated in the reverse direction, the rotation member 41 is rotated in the second rotational direction Dr2. When the rotation member 41 is rotated in the second rotational direction Dr2, the linear motion member 42 moves straight (moves) in the second direction Dt2 and moves away from the piston 12. According to the movement of the linear motion member 42 in the second direction Dt2, the pressing force of the piston 12 against the back plate 31 is reduced, and the pressing of the friction material 32 against the brake rotor 14 by the piston 12 is released. As a result, a release state (non-braking state) of braking by the electric brake function is obtained.

In the present embodiment, the ECU 19 of FIG. 1 controls the electric motor 18. The ECU 19 may be partially configured by hardware such as a CPU or a controller that executes software, or may be entirely configured by hardware. Note that the electric motor 18 is not limited to the ECU 19, and may be controlled by, for example, a dedicated controller of the braking device 10.

When receiving an instruction signal for shifting to the braking state from an operation switch (SW) of the electric brake function, for example, the ECU 19 controls the electric motor 18 so that the rotation member 41 rotates in the first rotational direction Dr1. On the other hand, when receiving an instruction signal for releasing the braking state from the operation switch, the ECU 19 controls the electric motor 18 so that the rotation member 41 rotates in the second rotational direction Dr2.

As illustrated in FIG. 2, the braking device 10 further includes an engagement structure 60. The engagement structure 60 includes recesses 61, 62, and 63 provided in the piston 12 and a protrusion 65 protruding from the brake pad 15.

The recesses 61, 62, and 63 are recessed in the second direction Dt2 from the end surface 12b of the piston 12. The recesses 61 and 62 are spaced apart to the outer side in the radial direction from the central axis Ax and open to the outer peripheral surface 12a and the end surface 12b of the piston 12. The recess 63 is provided along the central axis Ax and communicates with the recess 61 and the recess 62. Note that the piston 12 may be provided with only the recess 61.

The piston 12 has a recess first end surface 61a that comes into contact with the protrusion 65 of the back plate 31 when rotated in the second rotational direction Dr2, and a recess second end surface 61b that comes into contact with the protrusion 65 of the back plate 31 when rotated in the first rotational direction Dr1. In the present embodiment, the recess first end surface 61a and the recess second end surface 61b are planes substantially parallel to the central axis Ax. Note that the recess first end surface 61a and the recess second end surface 61b are not limited to this example.

The recess first end surface 61a is formed to be substantially flat and faces the second rotational direction Dr2. The recess second end surface 61b is formed to be substantially flat and faces the first rotational direction Dr1. In a projection plane in which the piston 12 is viewed in the second direction Dt2, each of the recess first end surface 61a and the recess second end surface 61b is extended linearly. In the present embodiment, in the projection plane, the extended line of the recess first end surface 61a and the extended line of the recess second end surface 61b intersect with each other at the central axis Ax. Note that the recess first end surface 61a and the recess second end surface 61b are not limited to this example.

The protrusion 65 protrudes in the second direction Dt2 from the receiving surface 31a of the back plate 31 at a position spaced apart to the outer side in the radial direction from the central axis Ax. The protrusion 65 is at least partially accommodated in the recess 61. That is, the protrusion 65 is located between the recess first end surface 61a and the recess second end surface 61b of the recess 61 in the circumferential direction. In the circumferential direction, the length of the protrusion 65 is shorter than the distance between the recess first end surface 61a and the recess second end surface 61b of the recess 61.

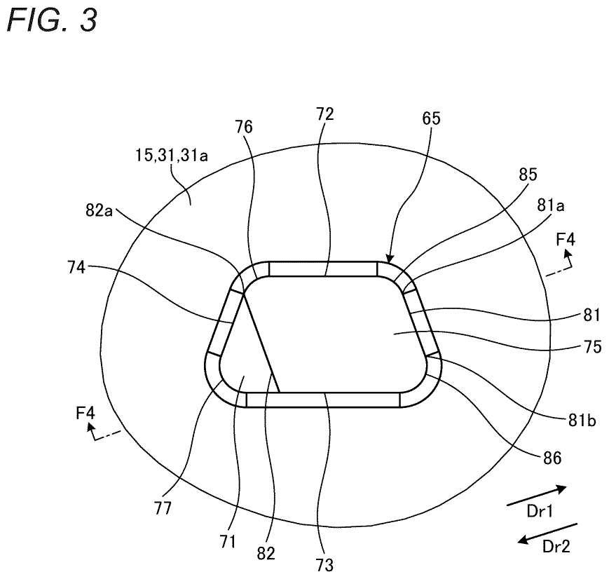

FIG. 3 is a plan view illustrating the protrusion 65 of the first embodiment. As illustrated in FIG. 3, the protrusion 65 is formed in a block shape having a substantially trapezoidal cross section tapered toward the central axis Ax. Note that the protrusion 65 is not limited to this example. The protrusion 65 of the present embodiment has an end surface 71, an inner surface 72, an outer surface 73, a regulation surface 74, and an inclined surface 75.

The end surface 71 is provided at the end portion of the protrusion 65 in the second direction Dt2. The end surface 71 is formed to be substantially flat and faces the second direction Dt2. That is, the end surface 71 is a plane substantially orthogonal to the axial direction.

The length of the protrusion 65 in the axial direction is shorter than the depth of the recess 61 in the axial direction. Therefore, the entire protrusion 65 can be accommodated in the recess 61. The length of the protrusion 65 in the axial direction is a distance between the receiving surface 31a and the end surface 71 in the axial direction.

The inner surface 72 is formed to be substantially flat and faces the inner side in the radial direction. In other words, the inner surface 72 faces the central axis Ax. The outer surface 73 is located on the opposite side of the inner surface 72. The outer surface 73 is formed to be substantially flat and faces the outer side in the radial direction.

The regulation surface 74 is an end portion of the protrusion 65 provided on a side that comes into contact with the recess second end surface 61b when the piston 12 is rotated in the first rotational direction Dr1. The regulation surface 74 is a plane substantially parallel to the central axis Ax. Note that the regulation surface 74 is not limited to this example. The regulation surface 74 is formed to be substantially flat. The regulation surface 74 faces the recess second end surface 61b when the recess second end surface 61b comes into contact with the protrusion 65. Furthermore, when the recess second end surface 61b comes into contact with the protrusion 65, the regulation surface 74 faces substantially the opposite side of the direction in which the recess second end surface 61b faces. However, in the present embodiment, the direction in which the regulation surface 74 faces is slightly different from the direction opposite to the direction in which the recess second end surface 61b faces.

The regulation surface 74 is connected to the end of the inner surface 72 closer to the recess second end surface 61b via a corner portion 76. Furthermore, the regulation surface 74 is connected to the end of the outer surface 73 closer to the recess second end surface 61b via a corner portion 77. The corner portions 76 and 77 are curved surfaces of a substantially semi-cylindrical shape. Note that the corner portions 76 and 77 are not limited to this example.

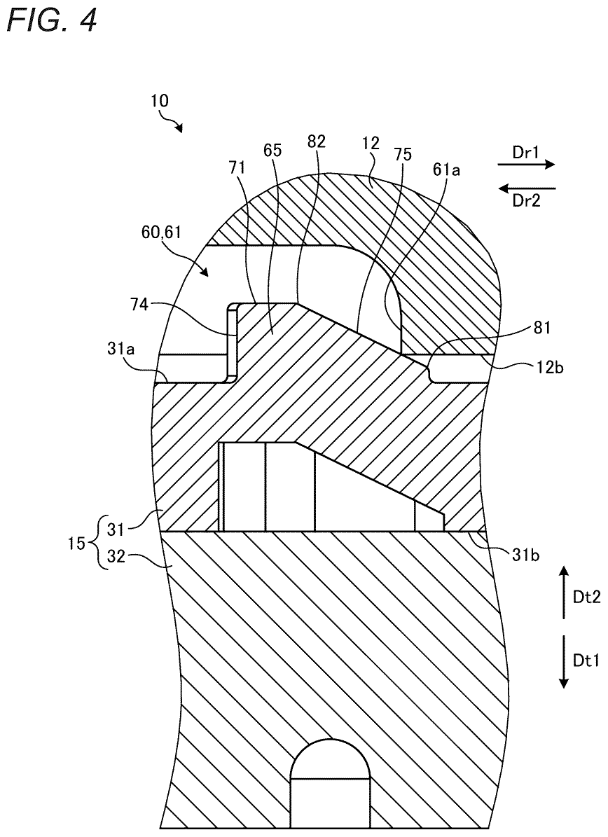

FIG. 4 is a cross-sectional view illustrating a part of the braking device 10 of the first embodiment taken along line F4-F4 of FIG. 3. As illustrated in FIG. 4, the inclined surface 75 is inclined obliquely with respect to the central axis Ax. In other words, the inclined surface 75 is not orthogonal to the central axis Ax and is not parallel to the central axis Ax.

The inclined surface 75 has a first edge 81 and a second edge 82. The first edge 81 is provided at an end portion of the inclined surface 75 in the first rotational direction Dr1. According to a different expression, the first edge 81 is provided at an end of the inclined surface 75 closer to the recess first end surface 61a. The second edge 82 is provided at an end portion of the inclined surface 75 in the second rotational direction Dr2. According to a different expression, the second edge 82 is provided at an end of the inclined surface 75 closer to the recess second end surface 61b. Thus, the second edge 82 is closer to the regulation surface 74 than the first edge 81.

As illustrated in FIG. 3, one end 81a of the first edge 81 is connected to an end of the inner surface 72 closer to the recess first end surface 61a via a corner portion 85. Furthermore, the other end 81b of the first edge 81 is connected to the end of the outer surface 73 closer to the recess first end surface 61a via a corner portion 86. The corner portions 85 and 86 are curved surfaces of a substantially semi-cylindrical shape. Note that the corner portions 85 and 86 are not limited to this example.

The first edge 81 is closer to the receiving surface 31a than the second edge 82. The second edge 82 is connected to the end surface 71. According to another expression, the second edge 82 forms a boundary between the end surface 71 and the inclined surface 75. The protrusion 65 is tapered in the second direction Dt2 by providing the above-described inclined surface 75.

In the present embodiment, each of the first edge 81 and the second edge 82 is extended linearly. The first edge 81 and the second edge 82 are substantially parallel to each other. The inclined surface 75 is extended flat between the first edge 81 and the second edge 82.

As illustrated in FIG. 2, on the projection plane in which the protrusion 65 is viewed in the first direction Dt1, each of the first edge 81 and the regulation surface 74 is extended linearly. On the projection plane, the extended line of the first edge 81 and the extended line of the regulation surface 74 intersect in a region Ab between the protrusion 65 and the central axis Ax. The region Ab is, for example, a region connecting the central axis Ax, the end of the protrusion 65 in the first rotational direction Dr1, and the end of the protrusion 65 in the second rotational direction Dr2.

In the present embodiment, on the projection plane in which the protrusion 65 is viewed in the first direction Dt1, the intersection of the extended line of the first edge 81 and the extended line of the regulation surface 74 is located on a line connecting the center of the protrusion 65 in the circumferential direction and the central axis Ax. Note that the intersection of the extended line of the first edge 81 and the extended line of the regulation surface 74 is not limited to this example.

On the other hand, on the projection plane in which the protrusion 65 is viewed in the first direction Dt1, the extended line of the recess first end surface 61a and the extended line of the recess second end surface 61b intersect at a position closer to the central axis Ax than the intersection of the extended line of the first edge 81 and the extended line of the regulation surface 74. In the present embodiment, as described above, the extended line of the recess first end surface 61a and the extended line of the recess second end surface 61b intersect each other on the central axis Ax. Note that the extended line of the recess first end surface 61a and the extended line of the recess second end surface 61b may intersect each other at other positions.

The protrusion 65 is formed on the back plate 31 by, for example, press working. Therefore, a depression is provided at a position on the opposite side of the protrusion 65 on the attachment surface 31b of the back plate 31. Note that the protrusion 65 is not limited to this example, and for example, may be formed by attaching a component different from the back plate 31 to the back plate 31.

When the rotation member 41 is rotated and the linear motion member 42 is moved in the axial direction, the linear motion member 42 may rotate around the central axis Ax together with the rotation member 41 due to, for example, friction between the male screw 57 and the female screw 58. The rotating linear motion member 42 causes the piston 12 to rotate about the central axis Ax since the projection 42c and the guide groove 12d are fitted to each other. That is, co-rotation of the rotation member 41 and the linear motion member 42 occurs in the piston 12.

When the piston 12 is rotated in the first rotational direction Dr1, the regulation surface 74 of the protrusion 65 abuts on the recess second end surface 61b. The brake pad 15 is supported by the caliper 11 so as to restrict the rotation of the brake pad 15. Therefore, the protrusion 65 provided on the brake pad 15 restricts further rotation of the piston 12 in the first rotational direction Dr1. That is, when the piston 12 is rotated in the first rotational direction Dr1, the protrusion 65 abuts on the recess second end surface 61b, thereby restricting the rotation of the piston 12 in the first rotational direction Dr1. In this manner, the engagement structure 60 restricts co-rotation of the piston 12 in the first rotational direction Dr1.

Both the recess second end surface 61b and the regulation surface 74 are planes substantially parallel to the central axis Ax. Therefore, the recess second end surface 61b and the regulation surface 74 can suppress a change in the force (braking force) with which the piston 12 presses the brake pad 15 against the brake rotor 14 while the recess second end surface 61b is pressing the regulation surface 74.

As illustrated in FIG. 4, when the piston 12 is rotated in the second rotational direction Dr2, the inclined surface 75 of the protrusion 65 comes into contact with the recess first end surface 61a. The recess first end surface 61a of the piston 12 driven in the second rotational direction Dr2 presses the inclined surface 75 in the second rotational direction Dr2.

The force with which the friction between the male screw 57 and the female screw 58 drives the piston 12 in the second rotational direction Dr2 is relatively small. Therefore, the reaction force acting on the recess first end surface 61a from the inclined surface 75 restricts the rotation of the piston 12 in the second rotational direction Dr2. That is, the protrusion 65 restricts further rotation of the piston 12 in the second rotational direction Dr2.

On the other hand, there is a case where the rotation member 41 is rotated in the second rotational direction Dr2, and the linear motion member 42 is moved in the second direction Dt2 to the maximum for, for example, replacement of the brake pad 15. When the linear motion member 42 is moved to the maximum in the second direction Dt2, the linear motion member 42 abuts on the flange 52 of the rotation member 41. In this case, the male screw 57 and the female screw 58 are tightened, and a state in which the rotation member 41 and the linear motion member 42 rotate integrally (locked state) is obtained. In the locked state, the force with which the rotation member 41 drives the linear motion member 42 and the piston 12 in the second rotational direction Dr2 becomes larger.

When the piston 12 is driven in the second rotational direction Dr2, the recess first end surface 61a presses the inclined surface 75 in the second rotational direction Dr2. Since the inclined surface 75 is inclined as described above, a component of the force with which the piston 12 presses the inclined surface 75 presses the inclined surface 75 in the first direction Dt1. That is, the piston 12 rotated in the second rotational direction Dr2 comes into contact with the inclined surface 75 at the recess first end surface 61a and presses the brake pad 15 in the first direction Dt1. As a result, the brake pad 15 and the piston 12 separate away from each other.

The energy of the piston 12 pressing the inclined surface 75 is consumed by the movement of the brake pad 15 and the piston 12. Therefore, in the locked state, loads applied to the electric motor 18 and the rotation transmission mechanism 17 are reduced. When the brake pad 15 and the piston 12 are separated away from each other and the protrusion 65 is detached from the recess 61, the loads applied to the electric motor 18 and the rotation transmission mechanism 17 are further reduced.

When the protrusion 65 is viewed in the first direction Dt1 as in FIG. 3, the projected area of the inclined surface 75 is greater than half of the projected area of the protrusion 65. In the present embodiment, one end 82a of the second edge 82 is connected to the corner portion 76. The end 82a of the second edge 82 may be connected to the inner surface 72. Thus, the end 82a of the second edge 82 is closer to the first edge 81 than the regulation surface 74. That is, with the provision of the inclined surface 75, the regulation surface 74 is not chipped, and the durability of the protrusion 65 when the regulation surface 74 abuts on the recess second end surface 61b is improved.

In the braking device 10 according to the first embodiment described above, the protrusion 65 protrudes out from the brake pad 15 and is accommodated in the recess 61 provided in the piston 12. The protrusion 65 has an inclined surface 75 inclined obliquely with respect to the central axis Ax. That is, the piston 12 rotated in the second rotational direction Dr2 comes into contact with the inclined surface 75 at the recess first end surface 61a and presses the brake pad 15 in the first direction Dt1. When the protrusion 65 is viewed in the first direction Dt1, the projected area of the inclined surface 75 is greater than half of the projected area of the protrusion 65. For example, in order to replace the brake pad 15, the rotation member 41 may be rotated in the second rotational direction Dr2 until the linear motion member 42 moves to the maximum in the second direction Dt2. When the linear motion member 42 moves to the maximum in the second direction Dt2, the linear motion member 42 and the rotation member 41 rotate integrally (locked state), and the rotation member 41, the linear motion member 42, and the piston 12 can rotate integrally in the second rotational direction Dr2. In the above-described braking device 10, the inclination of the inclined surface 75 with respect to the plane orthogonal to the central axis Ax is small as compared with the case where the projected area of the inclined surface 75 is smaller than half of the projected area of the protrusion 65. Therefore, when the piston 12 is rotated in the second rotational direction Dr2, the reaction force in the first rotational direction Dr1 received by the recess first end surface 61a from the inclined surface 75 decreases. Therefore, for example, the load applied to the electric motor 18 that drives the rotation member 41 and the rotation transmission mechanism 17 that transmits rotation between the electric motor 18 and the rotation member 41 is reduced, and the durability of the braking device 10 can be improved. In addition, the inclined surface 75 of the braking device 10 described above can lengthen the time from the start of the rotation of the piston 12 in the second rotational direction Dr2 until the recess first end surface 61a abuts on the inclined surface 75 as compared with the case where the projected area of the inclined surface 75 is smaller than half of the projected area of the protrusion 65. Therefore, for example, when the rotation of the piston 12 is stopped before the recess first end surface 61a abuts on the inclined surface 75, the frequency of applying a load to the electric motor 18 and the rotation transmission mechanism 17 can be reduced, and the durability of the braking device 10 can be improved.

The inclined surface 75 has a first edge 81 and a second edge 82. The first edge 81 is provided at an end portion of the inclined surface 75 in the first rotational direction Dr1. The second edge 82 is provided at the end portion of the inclined surface 75 in the second rotational direction Dr2 and is parallel to the first edge 81. The inclined surface 75 is extended flat between the first edge 81 and the second edge 82. As a result, when the piston 12 is rotated in the second rotational direction Dr2, the distance by which the recess first end surface 61a presses the inclined surface 75 becomes long. In addition, when the piston 12 is rotated in the second rotational direction Dr2, the reaction force in the first rotational direction Dr1 received by the recess first end surface 61a from the inclined surface 75 is suppressed from varying. Therefore, the load applied to the electric motor 18 and the rotation transmission mechanism 17 is alleviated, and the durability of the braking device 10 can be improved.

Each of the recess first end surface 61a and the recess second end surface 61b that comes into contact with the protrusion 65 when the piston 12 is rotated in the first rotational direction Dr1 is provided in parallel with the central axis Ax. If the recess first end surface 61a is inclined with respect to the central axis Ax, the contact area of the piston 12 and the brake pad 15 decreases as compared with the present embodiment in which the recess first end surface 61a is parallel to the central axis Ax. In the braking device 10 of the present embodiment, since the recess first end surface 61a is parallel to the central axis Ax, the change in the surface pressure between the piston 12 and the brake pad 15 can be reduced by designing to provide the inclined surface 75 so as to press the brake pad 15 in the first direction Dt1 when the piston 12 is rotated in the second rotational direction Dr2. Therefore, the braking device 10 can eliminate a concern that acoustic noise (noise) occurs.

The protrusion 65 has a regulation surface 74 that restricts the rotation of the piston 12 in the first rotational direction Dr1 by coming into contact with the recess second end surface 61b when the piston 12 is rotated in the first rotational direction Dr1. On the projection plane in which the protrusion 65 is viewed in the first direction Dt1, each of the first edge 81 and the regulation surface 74 is extended linearly. On the projection plane, the extended line of the first edge 81 and the extended line of the regulation surface 74 intersect in a region Ab between the protrusion 65 and the central axis Ax. On the other hand, on the projection plane, the extended line of the recess first end surface 61a and the extended line of the recess second end surface 61b intersect at a position closer to the central axis Ax than the intersection of the extended line of the first edge 81 and the extended line of the regulation surface 74. As a result, the recess first end surface 61a and the inclined surface 75 can abut on each other at a position farther from the central axis Ax. Therefore, when the piston 12 is rotated in the second rotational direction Dr2, the load generated between the recess first end surface 61a and the inclined surface 75 is reduced, and the durability of the braking device 10 can be improved.

### Second Embodiment

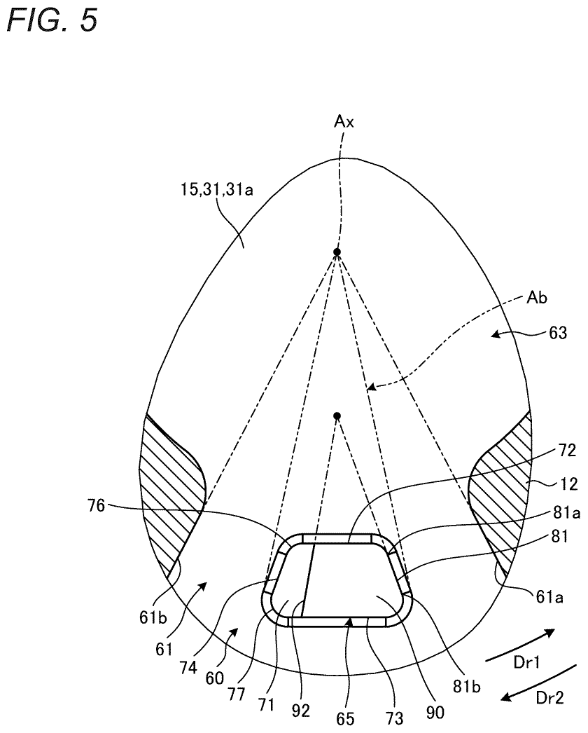

Hereinafter, a second embodiment will be described with reference to FIG. 5. Note that in the following description of the embodiment, components having functions similar to those of the components already described are denoted by the same reference numerals as those of the components already described, and the description thereof may be omitted. In addition, the plurality of components denoted by the same reference numerals do not necessarily have all the functions and properties in common, and may have different functions and properties according to each embodiment.

FIG. 5 is a plan view illustrating a part of a piston 12 and a brake pad 15 according to a second embodiment. Note that FIG. 5 illustrates a cross section of the piston 12. As illustrated in FIG. 5, the protrusion 65 of the second embodiment has an inclined surface 90 instead of the inclined surface 75. The inclined surface 90 is substantially equal to the inclined surface 75 of the first embodiment except for the following points.

The inclined surface 90 has a second edge 92 instead of the second edge 82. The second edge 92 is substantially equal to the second edge 82 of the first embodiment except for the points described below. The second edge 92 is extended linearly. However, the second edge 92 of the second embodiment is different from the second edge 82 of the first embodiment and is not parallel to the first edge 81.

As illustrated in FIG. 5, on the projection plane in which the protrusion 65 is viewed in the first direction Dt1, the extended line of the first edge 81 and the extended line of the second edge 92 intersect in a region Ab between the protrusion 65 and the central axis Ax. The extended line of the first edge 81 and the extended line of the second edge 92 may intersect with each other at the central axis Ax.

In the present embodiment, on the projection plane in which the protrusion 65 is viewed in the first direction Dt1, the intersection of the extended line of the first edge 81 and the extended line of the second edge 92 is located on a line connecting the center of the protrusion 65 in the circumferential direction and the central axis Ax. Note that the intersection of the extended line of the first edge 81 and the extended line of the second edge 92 is not limited to this example.

In the braking device 10 of the second embodiment described above, the inclined surface 90 has the first edge 81 and the second edge 92. The first edge 81 is provided at the end portion of the inclined surface 90 in the first rotational direction Dr1 and is extended linearly. The second edge 92 is provided at the end portion of the inclined surface 90 in the second rotational direction Dr2 and is extended linearly. On the projection plane in which the protrusion 65 is viewed in the first direction Dt1, the extended line of the first edge 81 and the extended line of the second edge 92 intersect with each other at the central axis Ax or in the region Ab between the protrusion 65 and the central axis Ax. That is, the first edge 81 and the second edge 92 are radially extended from a point in the vicinity of the central axis Ax. As a result, when the piston 12 is rotated in the second rotational direction Dr2, the recess first end surface 61a and the inclined surface 90 can be always in line contact with each other. Therefore, the surface pressure between the recess first end surface 61a and the inclined surface 90 is reduced, and the brake pad 15 and the piston 12 are suppressed from being damaged.

In the above embodiment, the first edge 81 and the second edge 82, 92 of the inclined surfaces 75, 90 are extended linearly. However, the first edge and the second edge of the inclined surface are not limited to these examples, and may be extended in a curved shape.

A braking device according to at least one embodiment described above includes, by way of example, a rotation member provided with one of a male screw and a female screw that meshes with the male screw, the rotation member being rotatable around a rotational axis; an electric motor that rotationally drives the rotation member, a linear motion member provided with the other of the male screw and the female screw, the linear motion member being movable in a first direction along the rotational axis when the rotation member is rotated in a first rotational direction around the rotational axis, and being movable in a second direction opposite to the first direction when the rotation member is rotated in a second rotational direction opposite to the first rotational direction; a brake pad spaced apart from the linear motion member in the first direction, a piston that is restricted from rotating around the rotational axis with respect to the linear motion member, is movable along the rotational axis with respect to the linear motion member, and is capable of pressing the brake pad in the first direction by being pressed in the first direction by the linear motion member, and a protrusion that protrudes from the brake pad, is accommodated in a recess provided in the piston, and has an inclined surface inclined with respect to the rotational axis, wherein the piston rotated in the second rotational direction comes into contact with the inclined surface of the brake pad at a recess first end surface, and presses the brake pad in the first direction, and when the protrusion is viewed in the first direction, a projected area of the inclined surface is greater than half of a projected area of the protrusion. For example, in order to replace the brake pad, the rotation member may be rotated in the second rotational direction until the linear motion member moves to the maximum in the second direction. When the linear motion member moves to the maximum in the second direction, the linear motion member and the rotation member rotate integrally (locked state), and the rotation member, the linear motion member, and the piston can rotate integrally in the second rotational direction. In the above-described braking device, the inclination of the inclined surface with respect to the plane orthogonal to the rotational axis is small as compared with the case where the projected area of the inclined surface is smaller than half of the projected area of the protrusion. Therefore, when the piston is driven in the second rotational direction, the reaction force in the first rotational direction received by the recess first end surface from the inclined surface decreases. Therefore, for example, the load applied to the electric motor that drives the rotation member and the rotation transmission mechanism that transmits rotation between the electric motor and the rotation member is reduced, and the durability of the braking device can be improved. In addition, the inclined surface of the braking device described above can lengthen the time from the start of the rotation of the piston in the second rotational direction until the recess first end surface abuts on the inclined surface, as compared with the case where the projected area of the inclined surface is smaller than half of the projected area of the protrusion. Therefore, for example, when the rotation of the piston is stopped before the recess first end surface abuts on the inclined surface, the frequency of applying a load to the electric motor and the drive mechanism can be reduced, and the durability of the braking device can be improved.

In the braking device, as an example, the inclined surface has a first edge provided at an end portion of the inclined surface in the first rotational direction and a second edge provided at an end portion of the inclined surface in the second rotational direction and parallel to the first edge, and extends flat between the first edge and the second edge. Therefore, as an example, when the piston is driven in the second rotational direction, the distance by which the recess first end surface presses the inclined surface becomes long. In addition, when the piston is driven in the second rotational direction, the reaction force in the first rotational direction received by the recess first end surface from the inclined surface is suppressed from varying. Therefore, the load applied to the electric motor and the drive mechanism is alleviated, and the durability of the braking device can be improved.

In the braking device, as an example, each of the recess first end surface and the recess second end surface that comes into contact with the protrusion when the piston is rotated in the first rotational direction is provided in parallel with the rotational axis. For example, if the recess first end surface and the recess second end surface are inclined obliquely with respect to the rotational axis, the contact area between the piston and the brake pad decreases as compared with the case where the recess first end surface and the recess second end surface are parallel to the rotational axis. In the above-described braking device, since the recess first end surface and the recess second end surface are parallel to the rotational axis, a change in surface pressure between the piston and the brake pad due to the design of providing an inclined surface that presses the brake pad in the first direction when the piston is driven in the second rotational direction can be reduced. Therefore, the braking device can eliminate a concern that acoustic noise (noise) occurs.

In the braking device, as an example, the protrusion has a regulation surface that comes into contact with the recess second end surface when the piston is rotated in the first rotational direction to restrict the rotation of the piston in the first rotational direction, each of the first edge and the regulation surface are extended linearly on a projection plane in which the protrusion is viewed in the first direction, an extended line of the first edge and an extended line of the regulation surface intersect in a region between the protrusion and the rotational axis, and the extended line of the recess first end surface and an extended line of the recess second end surface intersect at a position closer to the rotational axis than an intersection of the extended line of the first edge and the extended line of the regulation surface. Therefore, as an example, the recess first end surface and the inclined surface can abut on each other at a position farther from the rotational axis. Therefore, when the piston is rotated in the second rotational direction, the load generated between the recess first end surface and the inclined surface is reduced, and the durability of the braking device can be improved.

In the braking device, as an example, the inclined surface includes a first edge provided at an end portion of the inclined surface in the first rotational direction and extended linearly, and a second edge provided at an end portion of the inclined surface in the second rotational direction and extended linearly, and an extended line of the first edge and an extended line of the second edge intersect at the rotational axis or in a region between the protrusion and the rotational axis on a projection plane in which the protrusion is viewed in the first direction. Thus, as an example, the first edge and the second edge are extended radially from a point in the vicinity of the rotational axis. As a result, when the piston is driven in the second rotational direction, the recess first end surface and the inclined surface can always be in line contact with each other. Therefore, the surface pressure between the recess first end surface and the inclined surface is reduced, and the brake pad and the piston are suppressed from being damaged.

In the above description, suppression is defined as, for example, preventing the occurrence of an event, an action, or an influence, or reducing the degree of the event, the action, or the influence. Furthermore, in the above description, the restriction is defined as, for example, preventing movement or rotation, or allowing movement or rotation within a predetermined range and preventing movement or rotation beyond the predetermined range.

Although the embodiments of the present disclosure have been exemplified above, the above-described embodiments and modified example are merely examples, and are not intended to limit the scope of the disclosure. The embodiments and modified examples described above can be implemented in various other forms, and various omissions, replacements, combinations, and changes can be made within a scope not deviating from the gist of the disclosure. In addition, the configuration and shape of each embodiment and each modified example can be partially interchanged.

1. A braking device comprising:
a rotation member provided with one of a male screw and a female screw that meshes with the male screw, the rotation member being rotatable around a rotational axis;
an electric motor that rotationally drives the rotation member;
a linear motion member provided with the other of the male screw and the female screw, the linear motion member being movable in a first direction along the rotational axis when the rotation member is rotated in a first rotational direction around the rotational axis, and the linear motion member being movable in a second direction opposite to the first direction when the rotation member is rotated in a second rotational direction opposite to the first rotational direction;
a brake pad spaced apart from the linear motion member in the first direction;
a piston that is restricted from rotating around the rotational axis with respect to the linear motion member, is movable along the rotational axis with respect to the linear motion member, and is capable of pressing the brake pad in the first direction by being pressed in the first direction by the linear motion member; and
a protrusion that protrudes out from the brake pad, is accommodated in a recess provided in the piston, and has an inclined surface inclined obliquely with respect to the rotational axis; wherein
the piston rotated in the second rotational direction comes into contact with the inclined surface of the brake pad at a recess first end surface, and presses the brake pad in the first direction, and
when the protrusion is viewed in the first direction, a projected area of the inclined surface is greater than half of a projected area of the protrusion.

2. The braking device according to claim 1, wherein
the inclined surface has a first edge provided at an end portion of the inclined surface in the first rotational direction and a second edge provided at an end portion of the inclined surface in the second rotational direction and parallel to the first edge, and extends flat between the first edge and the second edge.

3. The braking device according to claim 2, wherein
each of the recess first end surface and the recess second end surface that comes into contact with the protrusion when the piston is rotated in the first rotational direction is provided in parallel with the rotational axis.

4. The braking device according to claim 3, wherein
the protrusion has a regulation surface that comes into contact with the recess second end surface when the piston is rotated in the first rotational direction to restrict the rotation of the piston in the first rotational direction; and
each of the first edge and the regulation surface are extended linearly on a projection plane in which the protrusion is viewed in the first direction, an extended line of the first edge and an extended line of the regulation surface intersect in a region between the protrusion and the rotational axis, and the extended line of the recess first end surface and an extended line of the recess second end surface intersect at a position closer to the rotational axis than an intersection of the extended line of the first edge and the extended line of the regulation surface.

5. The braking device according to claim 1, wherein
the inclined surface includes a first edge provided at an end portion of the inclined surface in the first rotational direction and extended linearly, and a second edge provided at an end portion of the inclined surface in the second rotational direction and extended linearly, and
an extended line of the first edge and an extended line of the second edge intersect at the rotational axis or in a region between the protrusion and the rotational axis on a projection plane in which the protrusion is viewed in the first direction.
